(19) United States
(12) Patent Application Publication
(10) Pub. No.: US 2016/0190971 A1
(43) Pub. Date: Jun. 30, 2016

(54) MOTOR CONTROLLER

(71) Applicant: TOYOTA JIDOSHA KABUSHIKI KAISHA, Toyota-shi., Aichi-ken (JP)

(72) Inventors: Toshifumi YAMAKAWA, Sunto-gun, Shizuoka-ken (JP); Masaki OKAMURA, Toyota-shi, Aichi-ken (JP); Naoyoshi TAKAMATSU, Sunto-gun, Shizuoka-ken (JP)

(73) Assignee: TOYOTA JIDOSHA KABUSHIKI KAISHA, Toyota-shi, Aichi-ken (JP)

(21) Appl. No.: 14/910,558

(22) PCT Filed: Jul. 30, 2014
(86) PCT No.: PCT/IB2014/001407

§ 371 Date: Feb. 5, 2016

(30) Foreign Application Priority Data
Aug. 9, 2013 (JP) 2013-165877

(51) Int. Cl. H02P 27/08

(52) U.S. Cl. CPC H02P 27/08

(57) ABSTRACT

Provided is a motor controller for controlling a motor system including a power converter, a smoothing capacitor and a three-phase AC motor. The motor controller includes a generation unit configured to generate a modulation signal by adding a third harmonic signal to a phase voltage command signal, and a control unit configured to control an operation of the power converter using the modulation signal. The third harmonic signal includes a first signal component that causes an absolute value of a signal level of the modulation signal to be greater than an absolute value of a signal level of the phase voltage command signal at a timing in which an absolute value of a signal level of a phase current becomes minimum in each phase

### BACKGROUND OF THE INVENTION

1. Field of the Invention

This invention relates to, for example, the technical field of a motor controller configured to control a motor system including a three-phase alternating current (AC) motor.

2. Description of Related Art

As one example of a control method for driving a three-phase AC motor, there is pulse width modulation (PWM) control. PWM control controls a power converter that converts a direct current (DC) voltage (DC power) into an AC voltage (AC power) according to the magnitude relation of a phase voltage command signal, which is set from the perspective of causing a phase current supplied to the three-phase AC motor to coincide with an intended value, and a carrier signal of a predetermined frequency (refer to Japanese Patent Application Publication No. 2004-120853 (JP 2004-120853 A)). Note that PWM control is also used for controlling a power converter that converts an AC voltage into a DC voltage (refer to Japanese Patent Application Publication No. 2010-263775 (JP 2010-263775 A)).

Meanwhile, a smoothing capacitor for suppressing fluctuations in the DC voltage that is input to the power converter or output from the power converter is often electrically connected in parallel with the power converter. In recent years, the downsizing of the smoothing capacity is often sought by reducing the capacity of the smoothing capacitor. Nevertheless, when the capacity of the smoothing capacitor is reduced, there is a possibility that ripples (so-called, pulsating component) of the inter-terminal voltage of the smoothing capacitor may relatively increase. Thus, the technique of using a third harmonic signal for suppressing (reducing) the foregoing ripples of the inter-terminal voltage of the smoothing capacitor is disclosed in JP 2010-263775 A and JP 2004-120853 A. Specifically, JP 2010-263775 A discloses a technique of controlling a switching element including a power converter so that a current waveform of the input current from the AC power supply coincides with a synthetic wave of a sine wave and a third harmonic wave of the same frequency as the AC power supply. JP 2004-120853 A discloses a technique of controlling an inverter circuit, which is an example of a power converter, by performing PWM control using a modulated wave obtained by superimposing a three-phase modulated wave and a third harmonic wave.

### SUMMARY OF THE INVENTION

Nevertheless, depending on the factor that causes the generation of ripples of the inter-terminal voltage of the smoothing capacitor, there is a technical problem in that the ripples of the inter-terminal voltage of the smoothing capacitor cannot be sufficiently suppressed only with the techniques disclosed in JP 2010-263775 A and JP 2004-120853 A.

This invention provides a motor controller capable of suitably suppressing ripples of the inter-terminal voltage of the smoothing capacitor.

<1> The motor controller for a motor system according to a first aspect of this invention includes: a DC power supply; a power converter configured to convert DC power supplied from the DC power supply into AC power; a smoothing capacitor electrically connected in parallel with the power converter; and a three-phase AC motor that is driven with the AC power output from the power converter, the motor controller including: an electronic control unit configured to: (a) generate a modulation signal by adding a third harmonic signal to a phase voltage command signal that defines an operation of the three-phase AC motor, the third harmonic signal including a first signal component that causes an absolute value of a signal level of the modulation signal to be greater than an absolute value of a signal level of the phase voltage command signal at a timing in which an absolute value of a signal level of a phase current supplied to the three-phase AC motor becomes minimum in each phase of the three-phase AC motor; and (b) control an operation of the power converter using the modulation signal.

According to the motor controller according to the aspect of this invention, it is possible to control a motor system. The motor system to be controlled by the motor controller includes a DC power supply, a smoothing capacitor, a power converter, and a three-phase AC motor. The DC power supply outputs DC power (that is, DC voltage or DC current). The smoothing capacitor is electrically connected in parallel with the power converter. Typically, the smoothing capacitor is electrically connected in parallel with the DC power supply. Accordingly, the smoothing capacitor can suppress the fluctuation in the inter-terminal voltage of the smoothing capacitor (that is, respective inter-terminal voltages of the DC power supply and the power converter). The power converter converts DC power supplied from the DC power supply into AC power (typically, three-phase AC power). Consequently, the three-phase AC motor is driven with the AC power that is supplied from the power converter to the three-phase AC motor.

In order to control this type of motor system, the motor controller includes an ECU (generation means and control means).

The generation means generates a modulation signal by adding a third harmonic signal to a phase voltage command signal. In other words, the generation means adds a third harmonic signal to a phase voltage command signal corresponding to each phase of the three-phase AC motor (that is, corresponding to each of the three phases of a U phase, a V phase and a W phase). Consequently, the generation means generates a modulation signal corresponding to each phase of the three-phase AC motor (that is, corresponding to each of the three phases of a U phase, a V phase and a W phase).

The phase voltage command signal is an AC signal that defines the operation of the three-phase AC motor. For example, the phase voltage command signal may be suitably set from the perspective of causing the torque output from the three-phase AC motor to coincide with an intended value.

The third harmonic signal is a signal (typically, AC signal) having a frequency that is triple the frequency of the phase voltage command signal. In this invention, the third harmonic signal particularly includes a first signal component, which is a third harmonic signal, that works to realize the following state at a timing in which an absolute value of a signal level (for instance, signal level based on zero level or reference level) of the phase current supplied to the three-phase AC motor becomes minimum (typically, zero). Note that the first signal component may also be a third harmonic signal that does not work to realize the following state at a timing that differs from the timing that the absolute value of the signal level of the phase current becomes minimum. However, the first signal component may also be a third harmonic signal that works to realize the following state even at a timing that differs from the timing that the absolute value of the signal level of the phase current becomes minimum.

Specifically, the first signal component is a signal component that works to cause the absolute value of the signal level of the modulation signal to be greater than the absolute value of the signal level of the phase voltage command signal at a timing that the absolute value of the signal level of the phase current becomes minimum (typically, zero) in each phase. To put it differently, the first signal component is a signal component that works that causes the absolute value of the signal level of the modulation signal at the timing that the absolute vale of the signal level of the phase current becomes minimum to be greater than the absolute value of the signal level of the phase voltage command signal at the same timing in each phase. For example, upon focusing an intended phase among the three phases, when a third harmonic signal including the first signal component is added to the phase voltage signal of an intended phase, the absolute value of the signal level of the modulation signal of the intended phase becomes greater than the absolute value of the signal level of the phase voltage command signal of the intended phase at the timing that the absolute value of the signal level of the phase current of the intended phase becomes minimum.

Note that, as the third harmonic signal, a common third harmonic signal that is commonly used for all three phases of the three-phase AC motor may also be used. In the foregoing case, this common third harmonic signal may be added to the phase voltage command signal of each phase. Otherwise, as the third harmonic signal, a third harmonic signal that is prepared individually for each of the three phases of the three-phase AC motor may also be used. In the foregoing case, the third harmonic phase corresponding to each phase may be added to the phase voltage command signal of each phase.

The control means controls the operation of the power converter using the modulation signal generated by the generation means. For example, the control means may also control the operation of the power converter according to the magnitude relation of the modulation signal and a carrier signal of a predetermined frequency. Consequently, the power converter supplies, to the three-phase AC motor, AC power according to the phase voltage command signal. Accordingly, the three-phase AC motor is driven in a mode according to the phase voltage command signal.

According to the motor controller explained above, ripples of the inter-terminal voltage of the smoothing capacitor can be suppressed more favorably. The reason for this is explained below.

Foremost, ripples of the inter-terminal voltage of the smoothing capacitor may be generated at the timing that the absolute value of the signal level of the phase current becomes minimum (typically, zero). More specifically, relatively large ripples may be generated locally at the timing that the absolute value of the signal level of the phase current becomes minimum in comparison to ripples that may be generated at other timings. Here, one factor that may cause the generation of relatively large ripples at the timing that the absolute value of the signal level of the phase current becomes minimum is that the operating state of the power converter enters a specific state at the timing that the absolute value of the signal level of the phase current becomes minimum (for instance, reflux mode in which most of the DC power supplied from the DC power supply is supplied to the smoothing capacitor without being supplied to the power converter as explained later with reference to the drawings). When giving consideration to this kind of factor that causes the generation of ripples, it is anticipated that the generation of relatively large ripples at the timing that the absolute value of the signal level of the phase current becomes minimum can be suppressed by adjusting (typically, shortening) the period that the operating state of the power converter enters a specific state at the timing that the absolute value of the signal level of the phase current becomes minimum.

Thus, as described above, the motor controller of this invention causes the absolute value of the signal level of the modulation signal to be greater than the absolute value of the signal level of the phase voltage command signal at the timing that the absolute value of the signal level of the phase current becomes minimum. Consequently, since the motor controller can control the operation of the power converter using the modulation signal, the motor controller can forcibly change the operating state of the power converter from a specific state to another state at the timing that the absolute value of the signal level of the phase current becomes minimum. Typically, the motor controller can promptly change the operating state of the power converter from a specific state to another state at the timing that the absolute value of the signal level of the phase current becomes minimum in comparison to the case of controlling the operation of the power converter with a phase voltage command signal to which a third harmonic signal has not been added. In other words, the motor controller can relatively shorten the period that the operating state of the power converter enters a specific state at the timing that the absolute value of the signal level of the phase current becomes minimum. Consequently, the motor controller can favorably suppress the generation of relatively large ripples at the timing that the absolute value of the signal level of the phase current becomes minimum. In other words, the motor controller can favorably suppress ripples of the inter-terminal voltage of the smoothing capacitor.

<2> In a second aspect of the motor controller of this invention, the first signal component may include a signal component in which (i) an absolute value of a signal level becomes greater than zero, and (ii) a polarity of the signal level becomes the same as a polarity of the phase voltage command signal of an intended phase at a timing in which an absolute value of a signal level of the phase current of the intended phase becomes minimum.

According to this aspect, the motor controller can suitably suppress the generation of relatively large ripples at a timing in which the absolute value of the signal level of the phase current becomes minimum by adding a third harmonic signal including this kind of first signal component to the phase voltage command signal.

<3> In a third aspect of the motor controller of this invention, the first signal component may include a signal component in which (i) an absolute value of a signal level becomes maximum, and (ii) a polarity of the signal level becomes the same as a polarity of the phase voltage command signal of an intended phase at a timing in which an absolute value of a signal level of the phase current of the intended phase becomes minimum.

According to this aspect, the motor controller can more suitably suppress the generation of relatively large ripples at a timing in which the absolute value of the signal level of the phase current becomes minimum by adding a third harmonic signal including this kind of first signal component to the phase voltage command signal.

<4> In a fourth aspect of the motor controller of this invention, the third harmonic signal may include a second signal component in which an absolute value of a signal level becomes minimum at a timing in which the absolute value of the signal level of the phase voltage command signal becomes minimum.

According to this aspect, the motor controller can suitably suppress the generation of ripples that are caused by the operating state of the power converter becoming a specific state at a timing that differs from a timing in which the absolute value of the signal level of the phase current becomes minimum by adding a third harmonic signal including this kind of second signal component to the phase voltage command signal.

<5> In a fifth aspect of the motor controller of this invention, the power converter includes a switching element, and the ECU (adjusting means) may control the operation of the power converter by controlling the switching element according to a magnitude relation of the modulation signal and a carrier signal of a predetermined frequency, and adjust a frequency of the carrier signal so that a switching count of the switching element controlled on the basis of the modulation signal approaches a switching count of the switching element controlled on the basis of the phase voltage command signal.

As explained in detail later with reference to the drawings, when the frequency of the carrier signal is not adjusted, the switching count of the switching element controlled on the basis of the modulation signal often becomes smaller than the switching count of the switching element controlled on the basis of the phase voltage command signal. Thus, when the power converter is controlled on the basis of the modulation signal, loss in the power converter is often reduced due to the reduction in the switching count in comparison to the case where the power converter is controlled on the basis of the phase voltage command signal.

Meanwhile, when the frequency of the carrier signal is adjusted (typically, increased), the switching count of the switching element controlled on the basis of the modulation signal will increase in comparison to the case where the frequency of the carrier signal is not adjusted (typically, increased). Thus, the adjusting means can adjust the frequency of the carrier signal so that the switching count of the switching element controlled on the basis of the modulation signal approaches the switching count of the switching element controlled on the basis of the phase voltage command signal. Here, so as long as the motor controller adjusts the frequency of the carrier signal to an extent that the switching count of the switching element controlled on the basis of the modulation signal does not exceed the switching count of the switching element controlled on the basis of the phase voltage command signal, it is possible to suitably yield the effect of reducing the loss of the power converter (that is, effect in which the loss will not increase). Accordingly, the motor controller can flexibly adjust the frequency of the carrier signal while suitably yielding this kind of effect of reducing the loss of the power converter (that is, effect in which the loss will not increase).

<6> In a sixth aspect of the motor controller including the adjusting means as described above, the adjusting means may adjust the frequency of the carrier signal so that the switching count of the switching element controlled on the basis of the modulation signal coincides with the switching count of the switching element controlled on the basis of the phase voltage command signal.

According to this aspect, the motor controller can adjust the frequency of the carrier signal while suitably yielding an effect in which the loss of the power converter will not increase.

<7> In a seventh aspect of the motor controller including the adjusting means as described above, the adjusting means increases the frequency of the carrier signal.

According to this aspect, the motor controller can increase the frequency of the carrier signal (so-called, carrier increase) while yielding the effect of reducing the loss of the power converter (that is, effect in which the loss will not increase). Consequently, the motor controller can also yield the effect of reducing noise in the power converter resulting from the carrier increase.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing a configuration of the vehicle of the first embodiment;

FIG. 2 is a block diagram showing a configuration of the ECU (in particular, a configuration for controlling the operation of an inverter);

FIG. 3 is a flowchart showing the flow of the inverter control operation in the first embodiment;

FIG. 4 is a graph showing third harmonic signals together with a three-phase voltage command signal and a three-phase current;

FIGS. 5A and 5B are respectively a graph and a block diagram explaining the reason why relatively large ripples are generated at a timing that the absolute value of the signal level of the three-phase current value becomes minimum (typically, zero);

FIGS. 6A and 6B are graphs showing the comparison of a ripples that is generated when a third harmonic signal is added to a three-phase voltage command signal and a ripples that is generated when a third harmonic signal is not added to a three-phase voltage command signal;

FIG. 7 is a graph showing another example of third harmonic signals together with a three-phase voltage command signal and a three-phase current;

FIG. 8 is a block diagram showing a configuration of the vehicle of the second embodiment;

FIG. 9 is a flowchart showing the flow of the inverter control operation in the second embodiment; and

FIGS. 10A to 10C are graphs showing the magnitude relation of a U phase voltage command signal and a U phase modulation signal and a carrier signal, and U phase PWM signals that are generated on the basis of the foregoing magnitude relation.

### DETAILED DESCRIPTION OF EMBODIMENTS

An embodiment of a vehicle controller is now explained.

### (1) First Embodiment

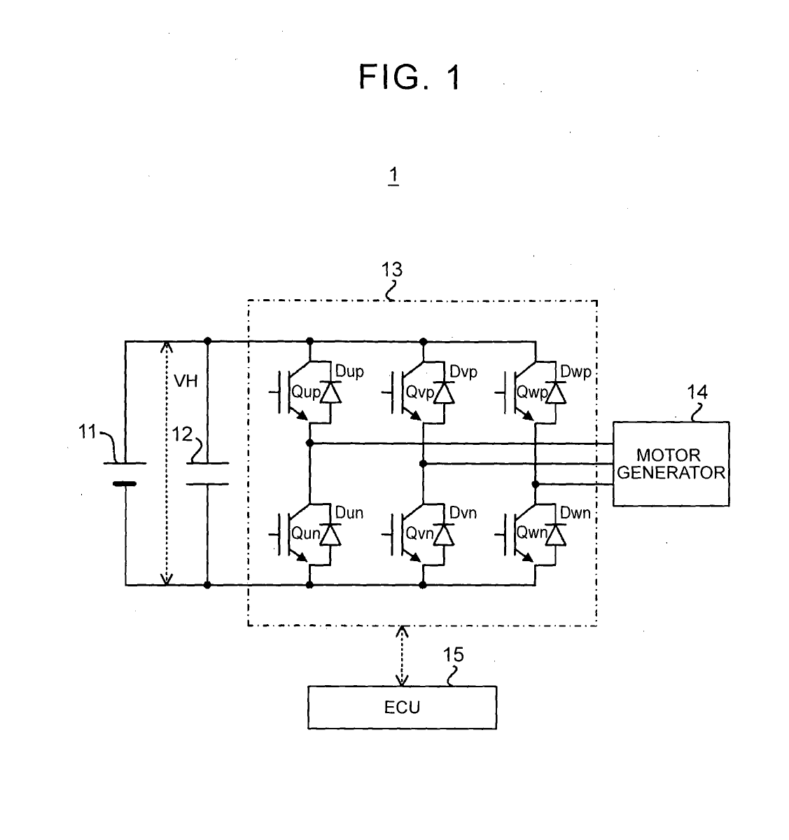

The first embodiment is foremost explained with reference to FIGS. 1 to 7.

### (1-1) Configuration of Vehicle of First Embodiment

The configuration of a vehicle 1 of the first embodiment is foremost explained with reference to FIG. 1. FIG. 1 is a block diagram showing the configuration of the vehicle 1 of the first embodiment.

As shown in FIG. 1, the vehicle 1 includes a DC power supply 11, a smoothing capacitor 12, an inverter 13 as a specific example of a “power converter”, a motor generator 14 as a specific example of a “three-phase AC motor”, and an electronic control unit (ECU) 15 as a specific example of a “motor controller”.

The DC power supply 11 is a chargeable electrical storage device. As examples of the DC power supply 11, there are, for example, a secondary battery (for instance, nickel-metal hydride battery or lithium-ion battery), and a capacitor (for instance, electric double layer phase capacitor or large-capacity).

The smoothing capacitor 12 is a voltage smoothing capacitor that is connected between a positive electrode line of the DC power supply 11 and a negative electrode line of the DC power supply 11. In other words, the smoothing capacitor 12 is a capacitor for smoothing the fluctuation of the inter-terminal voltage VH between the positive electrode line and the negative electrode line.

The inverter 13 converts DC power (DC voltage) supplied from the DC power supply 11 into AC power (three-phase AC voltage). In order to convert DC power (DC voltage) into AC power (three-phase AC voltage), the inverter 13 is equipped with a U phase arm including a p-side switching element Qup and an n-side switching element Qun, a V phase arm including a p-side switching element Qvp and an n-side switching element Qvn, and a W phase arm including a p-side switching element Qwp and an n-side switching element Qwn. The respective arms of the inverter 13 are connected in parallel between the positive electrode line and the negative electrode line. The p-side switching element Qup and the n-side switching element Qun are connected in series between the positive electrode line and the negative electrode line. The same applies to the p-side switching element Qvp and the n-side switching element Qvn, and to the p-side switching element Qwp and the n-side switching element Qwn. Connected to the p-side switching element Qup is a rectifier diode Dup that causes a current to flow from an emitter terminal of the p-side switching element Qup to a collector terminal of the p-side switching element Qup. A rectifier diode Dun to a rectifier diode Dwn are also similarly connected to the n-side switching element Qun to the n-side switching element Qwn, respectively. The middle point between an upper arm (that is, each p-side switching element) and a lower arm (that is, each n-side switching element) of each phase arm in the inverter 13 is connected to each phase coil of the motor generator 14. Consequently, the AC power (three-phase AC voltage) that is generated as a result of the conversion operation of the inverter 13 is supplied to the motor generator 14.

The motor generator 14 is a three-phase AC motor generator. The motor generator 14 is driven so as to generate torque that is required for the vehicle 1 to run. The torque generated by the motor generator 14 is transmitted to a drive wheel via a drive shaft that is mechanically coupled to a rotating shaft of the motor generator 14. Note that the motor generator 14 may also perform electric power regeneration (power generation) during the braking of the vehicle 1.

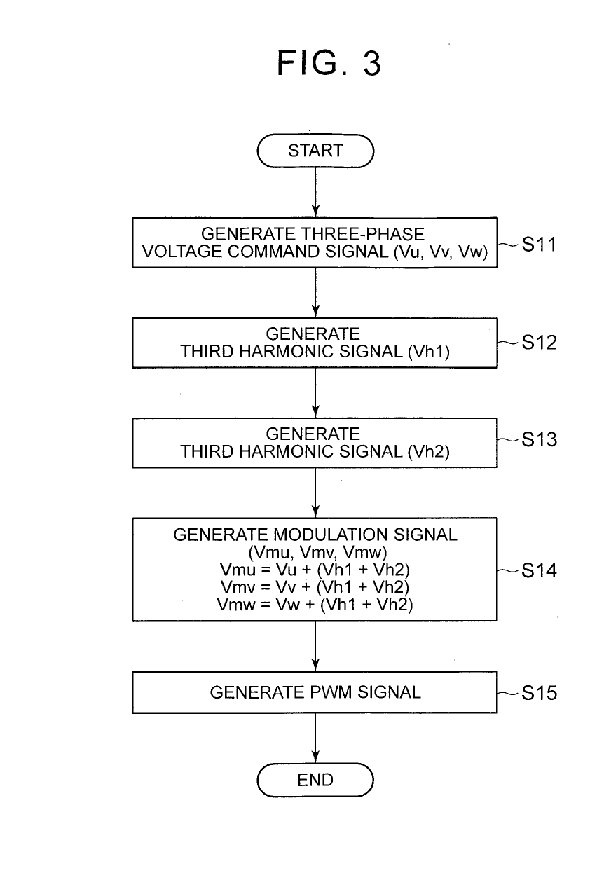

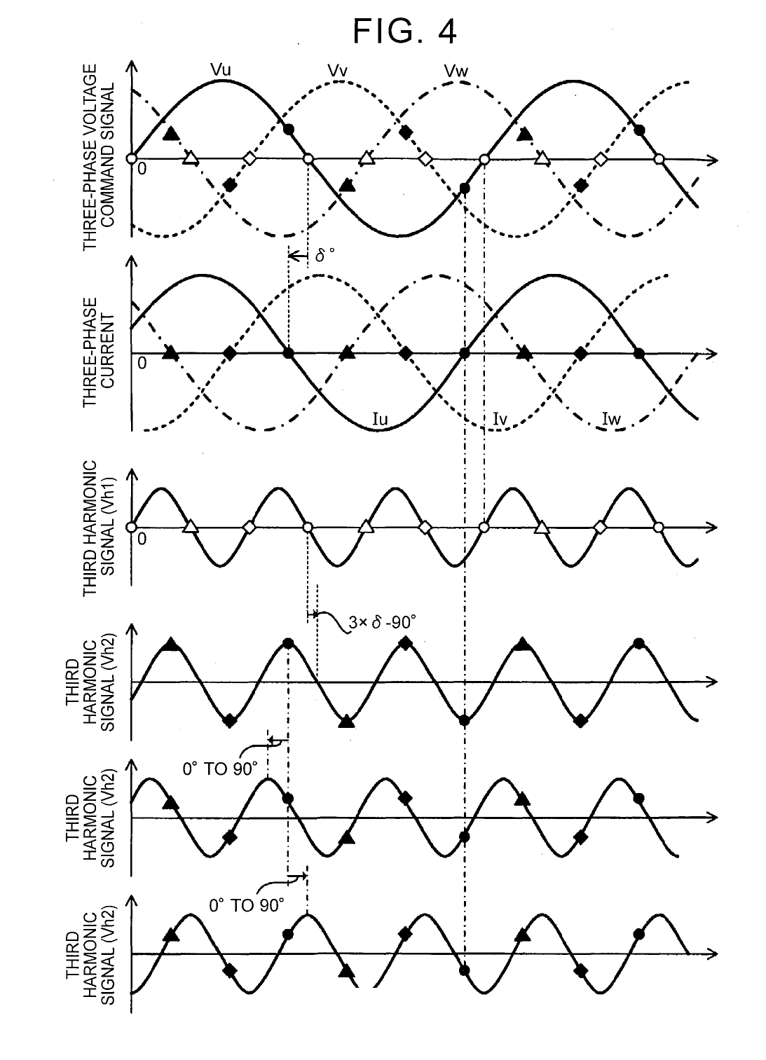

The ECU 15 is an electronic control unit for controlling the operation of the vehicle 1. Particularly, in the first embodiment, the ECU 15 performs the inverter control operation for controlling the operation of the inverter 13. Note that the inverter control operation performed by the ECU 15 will be described in detail later (with reference to FIGS. 3 and 4).

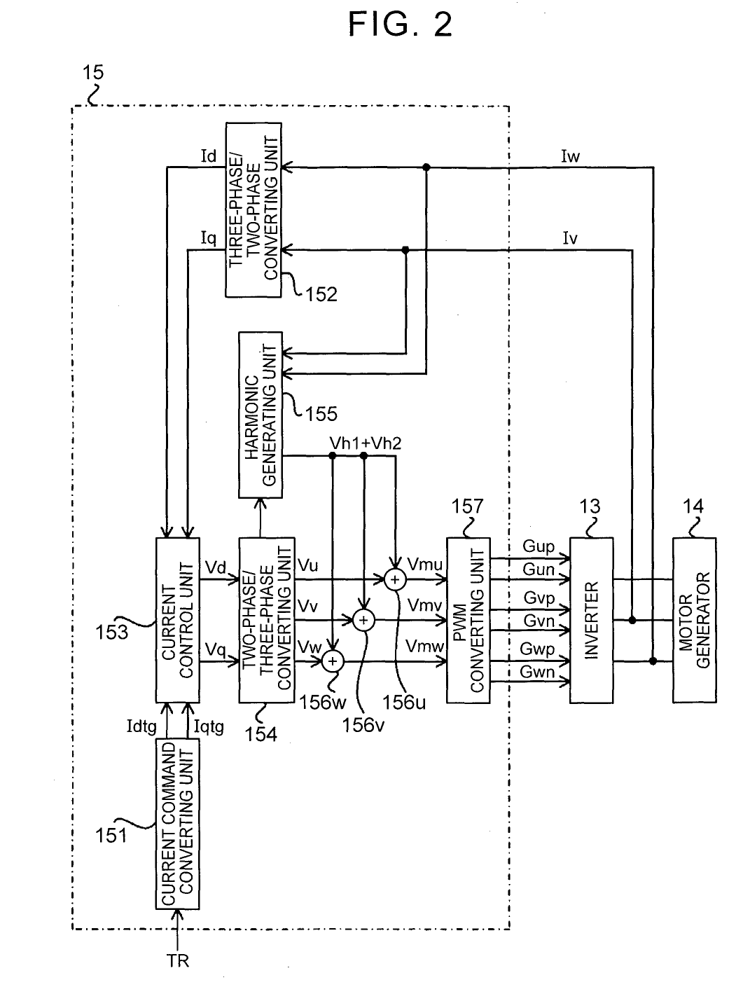

The configuration of the ECU 15 (in particular, configuration for controlling the operation of the inverter 13) is now explained with reference to FIG. 2. FIG. 2 is a block diagram showing a configuration of the ECU 15 (in particular, a configuration for controlling the operation of an inverter 13).

As shown in FIG. 2, the ECU 15 includes a current command converter 151, a three-phase/two-phase converting unit 152, a current control unit 153, a two-phase/three-phase converting unit 154, a harmonic generating unit 155, an adder 156u as a specific example of the “generation means”, an adder 156v as a specific example of the “generation means”, an adder 156w as a specific example of the “generation means”, and a PWM converting unit 157 as a specific example of the “control means”.

The current command converter 151 generates a two-phase current command signal (that is, a d-axis current command signal Idtg and a q-axis current command signal Iqtg) on the basis of a torque command value TR of the three-phase AC motor 14. The current command converter 151 outputs the d-axis current command signal Idtg and the q-axis current command signal Iqtg to the current control unit 153.

The three-phase/two-phase converting unit 152 acquires, from the inverter 13, a V phase current Iv and a W phase current Iw as feedback information. The three-phase/two-phase converting unit 152 converts the V phase current Iv and the W phase current Iw corresponding to a three-phase current value into a d-axis current Id and a q-axis current Iq corresponding to a two-phase current value. The three-phase/two-phase converting unit 152 outputs the d-axis current Id and the q-axis current Iq to the current control unit 153.

The current control unit 153 generates a d-axis voltage command signal Vd and a q-axis voltage command signal Vq corresponding to a two-phase voltage command signal on the basis of a difference between the d-axis current command signal Idtg and the q-axis current command signal Iqtg output from the current command converter 151, and the d-axis current Id and the q-axis current Iq output from the three-phase/two-phase converting unit 152. The current control unit 153 outputs the d-axis voltage command signal Vd and the q-axis voltage command signal Vq to the two-phase/three-phase converting unit 154.

The two-phase/three-phase converting unit 154 converts the d-axis voltage command signal Vd and the q-axis voltage command signal Vq into a U phase voltage command signal Vu, a V phase voltage command signal Vv and a W phase voltage command signal Vw as three-phase voltage command signals. The two-phase/three-phase converting unit 154 outputs the U phase voltage command signal Vu to the adder 156u. Similarly, the two-phase/three-phase converting unit 154 outputs the V phase voltage command signal Vv to the adder 156v. Similarly, the two-phase/three-phase converting unit 154 outputs the W phase voltage command signal Vw to the adder 156w.

The harmonic generating unit 155 generates a third harmonic signal including a frequency that is triple the frequency of the three-phase voltage command signal (that is, U phase voltage command signal Vu, V phase voltage command signal Vv and W phase voltage command signal Vw) and the three-phase current value (that is, U phase current Iu, V phase current Iv and W phase current Iw). Particularly, in the first embodiment, the harmonic generating unit 155 generates two types of third harmonic signals Vh1 and Vh2. Note that these two types of third harmonic signals Vh1 and Vh2 will be explained in detail later (with reference to FIGS. 3 and 4).

The adder 156u adds the two types of third harmonic signals Vh1 and Vh2 generated by the harmonic generating unit 155 to the U phase voltage command signal Vu output from the two-phase/three-phase converting unit 154. Consequently, the adder 156u generates a U phase modulation signal Vmu (=Vu+Vh1+Vh2). The adder 156u outputs the U phase modulation signal Vmu to the PWM converting unit 157.

The adder 156v adds the two types of third harmonic signals Vh1 and Vh2 generated by the harmonic generating unit 155 to the V phase voltage command signal Vv output from the two-phase/three-phase converting unit 154. Consequently, the adder 156v generates a V phase modulation signal Vmv (=Vv+Vh1+Vh2). The adder 156v outputs the V phase modulation signal Vmv to the PWM converting unit 157.

The adder 156w adds the two types of third harmonic signals Vh1 and Vh2 generated by the harmonic generating unit 155 to the W phase voltage command signal Vw output from the two-phase/three-phase converting unit 154. Consequently, the adder 156w generates a W phase modulation signal Vmw (=Vw+Vh1+Vh2). The adder 156w outputs the W phase modulation signal Vmw to the PWM converting unit 157.

The PWM converting unit 157 generates a U phase PWM signal Gup for driving the p-side switching element Qup and a U phase PWM signal Gun for driving the n-side switching element Qun on the basis of the magnitude relation of a carrier signal C of a predetermined carrier frequency f and the U phase modulation signal Vmu. For example, the PWM converting unit 157 may generate the U phase PWM signals Gup and Gun for turning ON the p-side switching element Qup when the U phase modulation signal Vmu, which is in a state of being smaller than the carrier signal C, coincides with the carrier signal C. Meanwhile, for example, the PWM converting unit 157 generates the U phase PWM signals Gup and Gun for turning ON the n-side switching element Qun when the U phase modulation signal Vmu, which is in a state of being larger than the carrier signal C, coincides with the carrier signal C. The PWM converting unit 157 outputs the U phase PWM signals Gup and Gun to the inverter 13. Consequently, the inverter 13 is (in particular, the p-side switching element Qup and the n-side switching element Qun configuring the U phase arm of the inverter 13 are) operated according to the U phase PWM signals Gup and Gun.

In addition, the PWM converting unit 157 generates a V phase PWM signal Gyp for driving the p-side switching element Qvp and a V phase PWM signal Gvn for driving the n-side switching element Qvn on the basis of the magnitude relation of the carrier signal C and the V phase modulation signal Vmv. In addition, the PWM converting unit 157 generates a W phase PWM signal Gwp for driving the p-side switching element Qwp and a W phase PWM signal Gwn for driving the n-side switching element Qwn on the basis of the magnitude relation of the carrier signal C and the W phase modulation signal Vmw. The mode of generating the V phase PWM signals Gyp and Gvn as well as the W phase PWM signals Gwp and Gwn is the same as the mode of generating the U phase PWM signals Gup and Gun.

### (1-2) Flow of Inverter Control Operation in First Embodiment

The flow of the inverter control operation that is performed in the vehicle 1 of the first embodiment (that is, the inverter control operation performed by the ECU 15) is now explained with reference to FIG. 3. FIG. 3 is a flowchart showing the flow of the inverter control operation in the first embodiment.

As shown in FIG. 3, the two-phase/three-phase converting unit 154 generates a three-phase voltage command signal (that is, a U phase voltage command signal Vu, a V phase voltage command signal Vv and a W phase voltage command signal Vw) (step S11). Note that the method of generating the three-phase voltage command signal is as per the method that was described above with reference to FIG. 2.

Parallel to, or before or after, the operation of step S11, the third harmonic generating unit 155 generates a third harmonic signal Vh1 as a specific example of the “second signal component” (step S12). Parallel to, or before or after, the operation of step S11 and step S12, the third harmonic generating unit 155 generates a third harmonic signal Vh2 as a specific example of the “first signal component” (step S13).

Here, the third harmonic signals Vh1 and Vh2 are explained with reference to FIG. 4. FIG. 4 is a graph showing the third harmonic signals Vh1 and Vh2 together with the three-phase voltage command signal and the three-phase current.

As shown in the third graph of FIG. 4, the third harmonic signal Vh1 is a third harmonic signal in which the absolute value of the signal level becomes minimum at the timing that the absolute value of the signal level of each of the U phase voltage command signal Vu, the V phase voltage command signal Vv and the W phase voltage command signal Vw (refer to first graph of FIG. 4) becomes minimum. To put it differently, the third harmonic signal Vh1 is a third harmonic signal that satisfies the condition of the phase in which the absolute value of the signal level of each of the U phase voltage command signal Vu, the V phase voltage command signal Vv and the W phase voltage command signal Vw becomes minimum coincides with the phase in which the absolute value of the signal level of the third harmonic signal Vh1 becomes minimum. In other words, the third harmonic signal Vh1 is a third harmonic signal in which the absolute value of the signal level becomes minimum at the timing that the absolute value of the signal level of at least one phase voltage command signal becomes minimum.

For example, the third harmonic signal Vh1 may also be a third harmonic signal in which the signal level becomes zero at the timing that the signal level of each of the U phase voltage command signal Vu, the V phase voltage command signal Vv and the W phase voltage command signal Vw becomes zero. To put it differently, the third harmonic signal Vh1 may also be a third harmonic signal that satisfies the condition of the phase in which the signal level of each of the U phase voltage command signal Vu, the V phase voltage command signal Vv and the W phase voltage command signal Vw becomes zero coincides with the phase in which the signal level of the third harmonic signal Vh1 becomes zero.

In the example shown in the third graph of FIG. 4, for example, the signal level of the third harmonic signal Vh1 becomes zero at the timing that the signal level of the U phase voltage command signal Vu becomes zero (refer to white circles in FIG. 4). Similarly, the signal level of the third harmonic signal Vh1 becomes zero at the timing that the signal level of the V phase voltage command signal Vv becomes zero (refer to white squares in FIG. 4). Similarly, the signal level of the third harmonic signal Vh1 becomes zero at the timing that the signal level of the W phase voltage command signal Vw becomes zero (refer to white triangles in FIG. 4).

The harmonic generating unit 155 may also generate the third harmonic signal Vh1 by referring to the three-phase voltage command signal generated by the two-phase/three-phase converting unit 154. For example, the harmonic generating unit 155 may generate the third harmonic signal Vhf by shifting the phase of an elementary signal of the third harmonic signal prescribed with the parameters stored in a memory or the like according to the phase of the three-phase voltage command signal generated by the two-phase/three-phase converting unit 154. Otherwise, for example, the harmonic generating unit 155 may also generate the third harmonic signal Vhf by generating an elementary signal of the third harmonic signal by dividing the three-phase voltage command signal, and shifting the phase of the generated elementary signal according to the phase of the three-phase voltage command signal generated by the two-phase/three-phase converting unit 154.

Meanwhile, as shown in the fourth graph of FIG. 4, the third harmonic signal Vh2 is a third harmonic signal in which the absolute value of the signal level becomes maximum at the timing that the absolute value of the signal level of each of the U phase current Iu, the V phase current Iv and the W phase current Iw (refer to second graph of FIG. 4) becomes minimum. To put it differently, the third harmonic signal Vh2 is a third harmonic signal that satisfies the condition of the phase in which the absolute value of the signal level of each of the U phase current Iu, the V phase current Iv and the W phase current Iw becomes minimum coincides with the phase in which the absolute value of the signal level of the third harmonic signal Vh2 becomes maximum. In other words, the third harmonic signal Vh2 is a third harmonic signal in which the absolute value of the signal level becomes maximum at the timing that the absolute value of the signal level of at least one phase current becomes minimum.

For example, the third harmonic signal Vh2 may also be a third harmonic signal in which the absolute value of the signal level becomes maximum at the timing that the signal level of each of the U phase current Iu, the V phase current Iv and the W phase current Iw becomes zero.

In addition, the third harmonic signal Vh2 is a third harmonic signal having a polarity that coincides with the polarity of the U phase voltage command signal Vu at the timing that the absolute value of the signal level of the U phase current Iu becomes minimum. In addition, the third harmonic signal Vh2 is a third harmonic signal having a polarity that coincides with the polarity of the V phase voltage command signal Vv at the timing that the absolute value of the signal level of the V phase current Iv becomes minimum. In addition, the third harmonic signal Vh2 is a third harmonic signal having a polarity that coincides with the polarity of the W phase voltage command signal Vw at the timing that the absolute value of the signal level of the W phase current Iw becomes minimum. In other words, the third harmonic signal Vh2 is a third harmonic signal having a polarity that coincides with the phase voltage command signal of an intended phase at the timing that the signal level of the phase current of the intended phase becomes minimum.

In the example shown in the fourth graph of FIG. 4, for example, (i) the absolute value of the signal level of the third harmonic signal Vh2 becomes maximum at the timing that the signal level of the U phase current Iu becomes zero (refer to black circles in FIG. 4), and (ii) the polarity of the signal level of the third harmonic signal Vh2 coincides with the polarity of the U phase voltage command signal Vu at the timing that the signal level of the U phase current Iu becomes zero. Similarly, for example, (i) the absolute value of the signal level of the third harmonic signal Vh2 becomes maximum at the timing that the signal level of the V phase current Iv becomes zero (refer to black squares in FIG. 4), and (ii) the polarity of the signal level of the third harmonic signal Vh2 coincides with the polarity of the V phase voltage command signal Vv at the timing that the signal level of the V phase current Iv becomes zero. Similarly, for example, (i) the absolute value of the signal level of the third harmonic signal Vh2 becomes maximum at the timing that the signal level of the W phase current Iw becomes zero (refer to black triangles in FIG. 4), and (ii) the polarity of the signal level of the third harmonic signal Vh2 coincides with the polarity of the W phase voltage command signal Vw at the timing that the signal level of the W phase current Iw becomes zero.

The harmonic generating unit 155 may also generate the third harmonic signal Vh2 by referring to the three-phase current value that can be acquired as feedback information from the inverter 13. For example, the harmonic generating unit 155 may generate the third harmonic signal Vh2 by shifting the phase of an elementary signal of the third harmonic signal prescribed with the parameters stored in a memory or the like according to the phase of the three-phase current value. Otherwise, for example, the harmonic generating unit 155 may generate an elementary signal of the third harmonic signal by dividing the three-phase current value or the three-phase voltage command signal, and may generate the third harmonic signal Vh2 by shifting the phase of the generated elementary signal according to the phase of the three-phase current value.

Otherwise, at the time that the two-phase/three-phase converting unit 154 generates the three-phase voltage command signal, the harmonic generating unit 155 may calculate a shift length 8 of the phase of the three-phase current that is based on the phase of the three-phase voltage command signal (for instance, shift length of the phase in which the signal level of the three-phase current value of an intended phase becomes zero that is based on the phase in which the signal level of the three-phase voltage command signal of the intended phase becomes zero). In the foregoing case, the harmonic generating unit 155 may also generate the third harmonic signal Vh2 by shifting the phase of the third harmonic signal Vh1 in an amount that is defined according to the shift length δ of the phase. For example, the harmonic generating unit 155 may also generate the third harmonic signal Vh2 by shifting the phase of the third harmonic signal Vh1 in the amount of 3×δ°−90° (provided, however, that the direction of the shift length δ of the phase described above (that is, direction from the phase in which the signal level of the three-phase voltage command signal of the intended phase becomes zero toward the phase of the signal level of the three-phase current value of the intended phase becomes zero) is the positive direction). Otherwise, the harmonic generating unit 155 may also generate the third harmonic signal Vh2 so that the phase which was shifted from the phase in which the signal level of the three-phase voltage command signal becomes zero to the phase that shifted in an amount defined according to the shift length δ coincides with the phase in which the signal level of the third harmonic signal Vh2 becomes zero. For example, the harmonic generating unit 155 may generate the third harmonic signal Vh2 from an elementary signal or the like of the third harmonic signal so that the phase that shifted in an amount of δ°−30° from the phase in which the signal level of the three-phase voltage command signal becomes zero coincides with the phase in which the signal level of the third harmonic signal Vh2 becomes zero.

Note that the third harmonic signal Vh2 does not need to be a third harmonic signal in which the absolute value of the signal level becomes maximum at the timing that the absolute value of the signal level of the three-phase current value becomes minimum. Specifically, the third harmonic signal Vh2 may also be a third harmonic signal in which the absolute value of the signal level becomes greater than zero at the timing that the absolute value of the signal level of the three-phase current value becomes minimum. To put it differently, the third harmonic signal Vh2 may also be a third harmonic signal in which the absolute value of the signal level does not become zero at the timing that the absolute value of the signal level of the three-phase current value becomes minimum. However, even in the foregoing case, the third harmonic signal Vh2 is a third harmonic signal having a polarity that coincides with the polarity of the phase voltage command signal of an intended phase at the timing that the signal level of the phase current of the intended phase becomes minimum. In order to generate the third harmonic signal Vh2 in which the absolute value of the signal level becomes greater than zero at the timing that the absolute value of the signal level of the three-phase current value becomes minimum, the harmonic generating unit 155 may also shift the phase of the third harmonic signal Vh1 in an amount of 3×δ°−X° (provided, however, that 0<X<180). Otherwise, the harmonic generating unit 155 may also the third harmonic signal Vh2 so that the phase that shifted in an amount of δ°−X/3° from the phase in which the signal level of the three-phase voltage command signal becomes zero coincides with the phase in which the signal level of the third harmonic signal Vh2 becomes zero. Otherwise, in order to generate the third harmonic signal Vh2 in which the absolute value of the signal level becomes greater than zero at the timing that the absolute value of the signal level of the three-phase current value becomes minimum, the harmonic generating unit 155 may also shift, in an amount of Y° (provided, however, that −90<Y<90), the phase of the third harmonic signal Vh2 in which the absolute value of the signal level becomes maximum at the timing that the absolute value of the signal level of the three-phase current value becomes minimum (refer to fourth graph of FIG. 4). Note that the fifth graph of FIG. 4 shows an example of the third harmonic signal Vh2 that is obtained by shifting, by an amount of Y1° (provided, however, that 0<Y1<90), the phase of the third harmonic signal Vh2 shown in the fourth graph of FIG. 4. Moreover, the sixth graph of FIG. 4 shows an example of the third harmonic signal Vh2 that is obtained by shifting, in an amount of Y2° (provided, however, that −90<Y2<0), the phase of the third harmonic signal Vh2 shown in the fourth graph of FIG. 4.

Returning to FIG. 3, the adder 156u adds the third harmonic signal Vh1 generated in step S12 and the third harmonic signal Vh2 generated in step S13 to the U phase voltage command signal Vu generated in step S11. Consequently, the adder 156u generates the U phase modulation signal Vmu (=Vu+Vh1+Vh2) (step S14). The adder 156v similarly generates the V phase modulation signal Vmv (=Vv+Vh1+Vh2) (step S14). The adder 156w also similarly generates the W phase modulation signal Vmw (=Vw+Vh1+Vh2) (step S14).

Subsequently, the PWM converting unit 157 generates the U phase PWM signals Gup and Gun on the basis of the magnitude relation of the carrier signal C and the U phase modulation signal Vmu (step S15). Similarly, the PWM converting unit 157 generates the V phase PWM signals Gyp and Gvn on the basis of the magnitude relation of the carrier signal C and the V phase modulation signal Vmv (step S15). Similarly, the PWM converting unit 157 generates the W phase PWM signals Gwp and Gwn on the basis of the magnitude relation of the carrier signal C and the W phase modulation signal Vmw (step S15). Consequently, the inverter 13 is driven on the basis of the respective PWM signals.

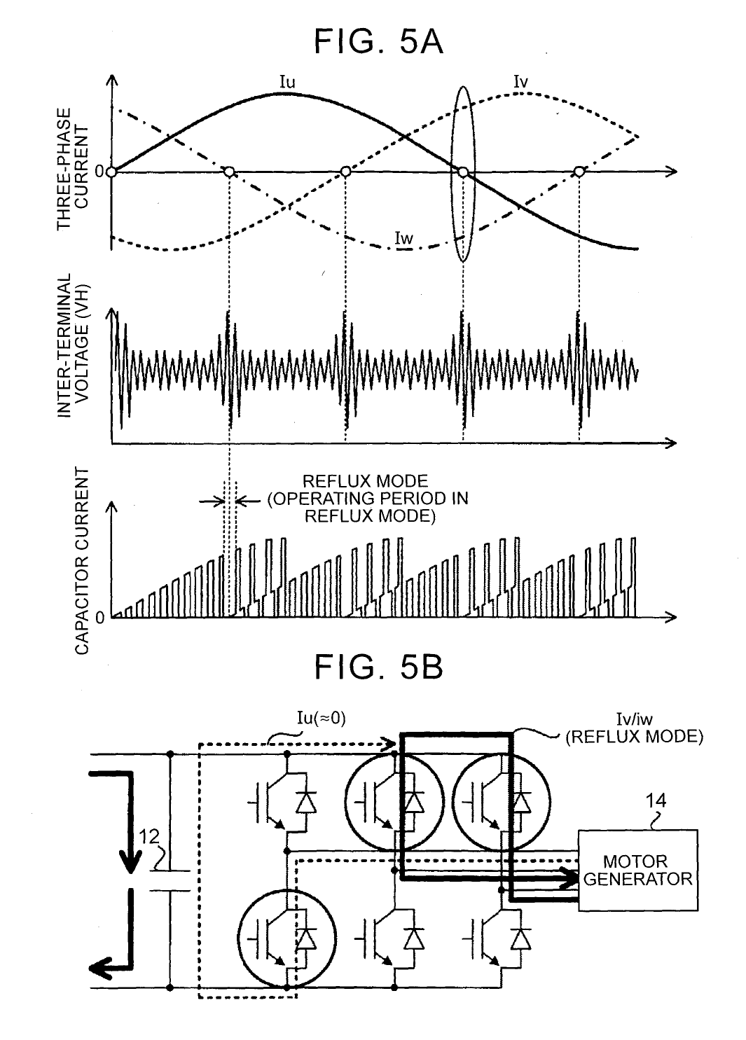

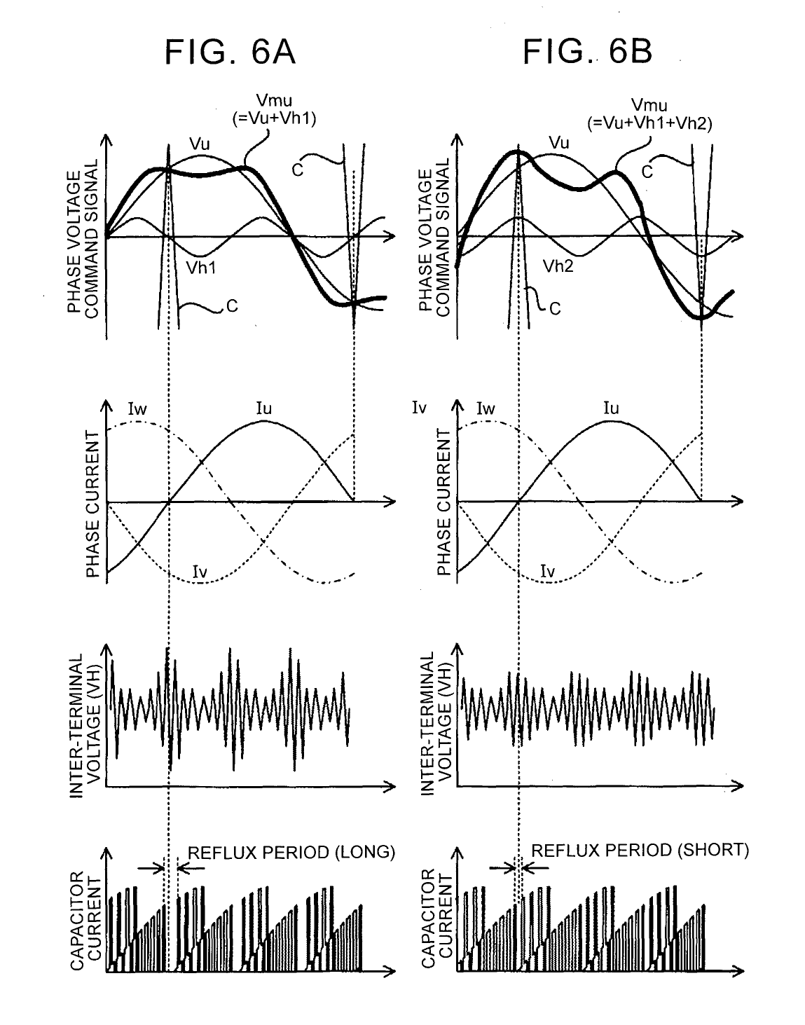

According to the inverter control operation of the first embodiment explained above, ripples of the inter-terminal voltage VH of the smoothing capacitor 12 are suitably suppressed in comparison to the inverter control operation of the comparative example that does not use the foregoing third harmonic signal Vh2. More specifically, generation of relatively large ripples at the timing of the absolute value of the signal level of the three-phase current value becomes minimum (typically, zero) is favorably suppressed. The reason for this is now explained with reference to FIGS. 5A and 5B, and FIGS. 6A and 6B. FIGS. 5A and 5B are respectively a graph and a block diagram explaining the reason why relatively large ripples are generated at a timing that the absolute value of the signal level of the three-phase current value becomes minimum (typically, zero). FIGS. 6A and 6B are graphs showing the comparison of a ripples that is generated when a third harmonic signal Vh2 is added to a three-phase voltage command signal and a ripples that is generated when a third harmonic signal Vh2 is not added to a three-phase voltage command signal.

As shown in FIG. 5A, ripples of the inter-terminal voltage VH of the smoothing capacitor 12 become relatively large at the timing that the absolute value of the signal level of each of the U phase current Iu, the V phase current Iv and the W phase current Iw becomes minimum (in the example shown in FIG. 5A, becomes zero). The ensuing explanation is provided by focusing on the timing that the signal level of the U phase current Iu becomes zero. However, the same could be said for the timing that the signal level of the V phase current Iv becomes zero and the timing that the signal level of the W phase current Iw becomes zero.

As shown in the first graph of FIG. 5A, at the timing, or before or after the timing, that the signal level of the U phase current Iu becomes zero, the V phase current Iv and the W phase current Iw have a relation in which the absolute value of the signal level of the V phase current Iv and the absolute value of the signal level of the W phase current Iw are approximate, or substantially or nearly coincide. In addition, at the timing that the signal level of the U phase current Iu becomes zero, the V phase current Iv and the W phase current Iw have a relation in which the polarity of the V phase current Iv becomes the opposite to the polarity of the W phase current Iw. Consequently, as shown in FIG. 5B, most or nearly all of the current flowing in the inverter 13 (for instance, currently flowing from the motor generator 14 toward the inverter 13, or current flowing from the inverter 13 toward the motor generator 14) will flow back from the motor generator 14 to the motor generator 14 via the V phase arm and the W phase arm of the inverter 13. In other words, it could be said that, in effect, the inverter 13 is operating in a reflux mode in which most or nearly all of the current that is flowing from the motor generator 14 to the inverter 13 flows out directly to the motor generator 14. While the inverter 13 is operating in this kind of reflux mode, the capacitor current (that is, current flowing through the smoothing capacitor 12) becomes zero or a value that is substantially approximate to zero (refer to third graph of FIG. 5A). While the inverter 13 is operating in the reflux mode, most or nearly all of the DC power supplied from the DC power supply 11 is supplied to the smoothing capacitor 12. Consequently, the inter-terminal voltage VH of the smoothing capacitor 12 tends to increase.

Accordingly, in order to suppress ripples of the inter-terminal voltage VH that may be generated at the timing that the signal level of each of the U phase current Iu, the V phase current Iv and the W phase current Iw becomes zero, it is anticipated that it would be preferably to shorten the period that the inverter 13 is operating in the reflux mode. Thus, in the first embodiment, the ECU 15 operates the inverter 13 using the U phase modulation signal Vmu, the V phase modulation signal Vmv and the W phase modulation signal Vmw that are generated by adding the third harmonic signal Vh2 in order to shorten the period that the inverter 13 is operating in the reflux mode.

Here, the third harmonic signal Vh2 has properties in which the absolute value of the signal level becomes maximum (otherwise, greater than zero) at the timing that the signal level of each of the U phase current Iu, the V phase current Iv and the W phase current Iw becomes zero. In addition, the third harmonic signal Vh2 has properties of having a polarity that coincides with the polarity of the phase voltage command signal of a predetermined phase at the timing in which the absolute value of the signal level of the phase current of the predetermined phase becomes minimum.

Accordingly, as shown in the first graph of FIG. 6B, the absolute value of the signal level of the U phase modulation signal Vmu that is generated by adding the third harmonic signal Vh2 to the U phase voltage command signal Vu becomes greater than the absolute value of the signal level of the U phase voltage command signal Vu at the timing that the signal level of the U phase current Iu becomes zero. Note that, while not shown in order to simplify the drawings, the absolute value of the signal level of the V phase modulation signal Vmv that is generated by adding the third harmonic signal Vh2 to the V phase voltage command signal Vv becomes greater than the absolute value of the signal level of the V phase voltage command signal Vv at the timing that the signal level of the V phase current Iv becomes zero. Similarly, while not shown in order to simplify the drawings, the absolute value of the signal level of the W phase modulation signal Vmw that is generated by adding the third harmonic signal Vh2 to the W phase voltage command signal Vw becomes greater than the absolute value of the signal level of the W phase voltage command signal Vw at the timing that the signal level of the W phase current Iw becomes zero.

Meanwhile, as shown in the first graph of FIG. 6A, the absolute value of the signal level of the U phase modulation signal Vmu that is generated without adding the third harmonic signal Vh2 does not become greater than the absolute value of the signal level of the U phase voltage command signal Vu at the timing that the signal level of the U phase current Iu becomes zero. Note that, while not shown in order to simplify the drawings, the absolute value of the signal level of the V phase modulation signal Vmv that is generated without adding the third harmonic Vh2 signal does not become greater than the absolute value of the signal level of the V phase voltage command signal Vv at the timing that the signal level of the V phase current Iv becomes zero. Similarly, while not shown in order to simplify the drawings, the absolute value of the signal level of the W phase modulation signal Vmw that is generated without adding the third harmonic signal Vh2 does not become greater than the absolute value of the signal level of the W phase voltage command signal Vw at the timing that the signal level of the W phase current Iw becomes zero.

Consequently, as shown in each of the first graphs of FIGS. 6A and 6B, when the third harmonic signal Vh2 is added, the period that the U phase modulation signal Vmu falls below the carrier signal C at the timing that the signal level of the U phase current Iu becomes zero will be shorter in comparison to the case where the third harmonic signal Vh2 is not added (provided, however, that this applied when the U phase modulation signal Vmu is of a positive polarity). Otherwise, the period that the U phase modulation signal Vmu exceeds the carrier signal C at the timing that the signal level of the U phase current Iu becomes zero will be shorter (provided, however, that this applies when the U phase modulation signal Vmu is of a negative polarity). When the period that the U phase modulation signal Vmu falls below or exceeds the carrier signal C is shortened, the switching state of the respective switching elements that cause the inverter 13 to operate in the reflux mode is changed. In other words, when the period that the U phase modulation signal Vmu falls below or exceeds the carrier signal C is shortened, the period that the inverter 13 operates in the reflux mode is also shortened (refer to fourth graphs of FIGS. 6A and 6B). Accordingly, as shown in each of the third graphs of FIGS. 6A and 6B, when the third harmonic signal Vh2 is added, ripples of the inter-terminal voltage VH that may be generated at the timing that the signal level of the U phase current Iu becomes zero are favorably suppressed in comparison to the case where the third harmonic signal Vh2 is not added. Note that, based on similar reasons, ripples of the inter-terminal voltage VH that may be generated at the timing that the signal level of each of the V phase current Iv and the W phase current Iw becomes zero are also favorably suppressed.

Note that FIG. 6B shows the inter-terminal voltage VH and the capacitor current in the case of using the third harmonic signal Vh2 in which the absolute value of the signal level becomes maximum at the timing that the signal level of the three-phase current value becomes zero. Nevertheless, even in cases of using the third harmonic signal Vh2 in which the absolute value of the signal level becomes greater than zero (provided, however, that the absolute value of the signal level will not become maximum) at the time that the signal level of the three-phase current value becomes zero, it goes without saying that similar technical effects are yielded. In other words, even in cases of using the third harmonic signal Vh2 that is obtained by shifting, in an amount of Y° (provided, however, that −90<Y<90), the phase of the third harmonic signal Vh2 (refer to FIG. 6B) in which the absolute value of the signal level becomes maximum at the timing that the signal level of the three-phase current value becomes zero, it goes without saying that similar technical effects are yielded. For example, even in cases of using the third harmonic wave Vh2 that is obtained by shifting, in an amount of Y1° (provided, however, that 0<Y1<90), the phase of the harmonic signal Vh2 shown in FIG. 6B, the period that the inverter 13 operates in the reflux mode is shortened and, consequently, ripples of the inter-terminal voltage VH are also suppressed. Similarly, for example, even in cases of using the third harmonic wave Vh2 that is obtained by shifting, in an amount of Y2° (provided, however, that −90<Y2<0), the phase of the harmonic signal Vh2 shown in FIG. 6B, the period that the inverter 13 operates in the reflux mode is shortened and, consequently, ripples of the inter-terminal voltage VH are also suppressed.

Moreover, when giving consideration to the technical effects that are obtained from the third harmonic signal Vh2, it could be said that the third harmonic signal Vh2 is a third harmonic signal having properties of working to cause the absolute value of the signal level of the phase modulation signal of a predetermined phase to become greater than the absolute value of the signal level of the phase voltage command signal of the predetermined phase at the timing that the absolute value of the signal level of the phase current of the predetermined phase becomes minimum. In other words, it could be said that the third harmonic signal Vh2 has properties of working to cause the absolute value of the signal level of the U phase modulation signal Vmu to become greater than the absolute value of the signal level of the U phase voltage command signal Vu at the timing that the absolute value of the signal level of the U phase current Iu becomes minimum. Similarly, it could be said that the third harmonic signal Vh2 has properties of working to cause the absolute value of the signal level of the V phase modulation signal Vmv to become greater than the absolute value of the signal level of the V phase voltage command signal Vv at the timing that the absolute value of the signal level of the V phase current Iv becomes minimum. Similarly, it could be said that the third harmonic signal Vh2 has properties of working to cause the absolute value of the signal level of the W phase modulation signal Vmw to become greater than the absolute value of the signal level of the W phase voltage command signal Vw at the timing that the absolute value of the signal level of the W phase current Iw becomes minimum. Accordingly, in addition to the third harmonic signals illustrated in FIG. 4, the third harmonic signal Vh2 may also be any type of signal so as long as it is a third harmonic signal having the foregoing properties.

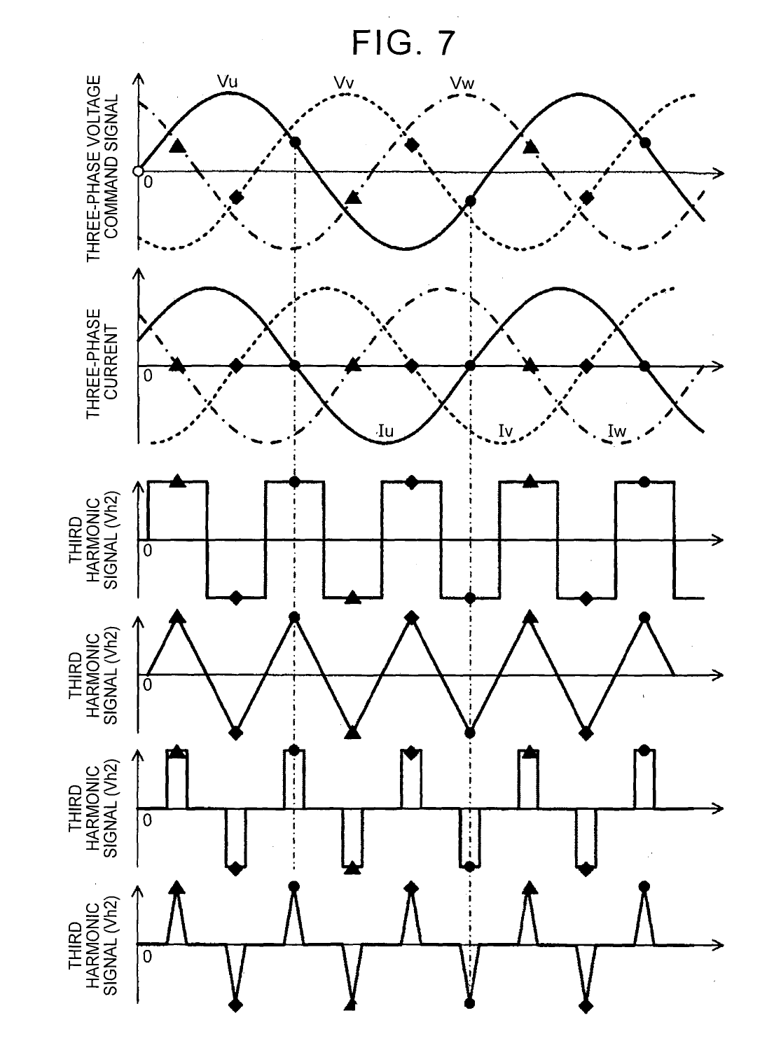

Moreover, the foregoing explanation described a case in which the third harmonic signal Vh2 is a sine wave (refer to FIG. 4). Nevertheless, the third harmonic signal Vh2 may also be a three-phase voltage command signal or an arbitrary AC signal having a frequency that is triple the frequency of the three-phase current value. For example, as shown in the third and fifth graphs of FIG. 7, the third harmonic signal Vh2 may also be a square wave (so-called pulse wave). Otherwise, for example, as shown in the fourth and sixth graphs of FIG. 7, the third harmonic signal Vh2 may also be a triangular wave signal. Otherwise, the third harmonic signal Vh2 may also be a signal in the shape of a saw-tooth wave or other shapes. The bottom line is that the third harmonic signal Vh2 needs to be a three-phase voltage command signal or a signal in which a same waveform pattern (preferably a same waveform pattern in which the signal level changes) appears periodically at a cycle corresponding to a frequency that is triple the frequency of the three-phase current value. The same applies to the third harmonic signal Vh1.

Moreover, the foregoing explanation described a case in which the vehicle 1 includes a single motor generator 14. Nevertheless, the vehicle 1 may also include a plurality of motor generators 14. In the foregoing case, the vehicle 1 preferably includes a corresponding inverter 13 for each motor generator 14. Moreover, in the foregoing case, the ECU 15 may also perform the foregoing inverter control operation independently for each inverter 13. Otherwise, the vehicle 1 may also include an engine in addition to the motor generator 14. In other words, the vehicle 1 may also be a hybrid vehicle.

Moreover, the foregoing explanation described a case in which the inverter 13 and the motor generator 14 are installed in the vehicle 1. Nevertheless, the inverter 13 and the motor generator 14 may also be installed in arbitrary equipment other than the vehicle 1 (for instance, equipment that is operated with the inverter 13 and the motor generator 14; for example, air-conditioning equipment). It goes without saying that the various effects described above can also be yielded in cases where the inverter 13 and the motor generator 14 are installed in arbitrary equipment other than the vehicle 1.

### (2) Second Embodiment

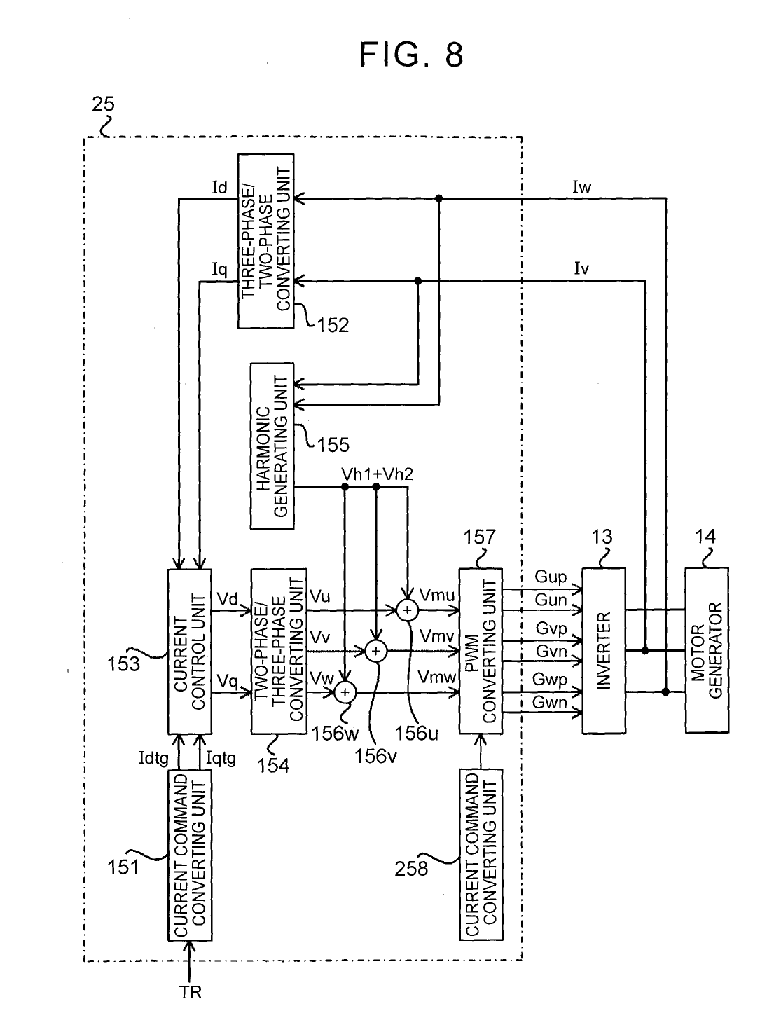

The second embodiment is now explained with reference to FIGS. 8, 9 and 10A to 10C. Note that the same reference number and step number are given to the constituent elements and operation of the vehicle 1 in the first embodiment, and the detailed explanation thereof is omitted.

### (2-1) Configuration of Vehicle of Second Embodiment

The configuration of a vehicle 2 of the second embodiment is foremost explained with reference to FIG. 8. FIG. 8 is a block diagram showing a configuration of the vehicle 2 of the second embodiment.

As shown in FIG. 8, the vehicle 2 of the second embodiment differs from the vehicle 1 of the first embodiment with respect to the point of including an ECU 25 in substitute for the ECU 15. More specifically, the vehicle 2 of the second embodiment differs from the vehicle 1 of the first embodiment, in which the ECU 15 does not need to be equipped with a frequency adjusting unit 258, with respect to the point that the ECU 25 including the frequency adjusting unit 258 as a specific example of the “adjusting means”. The other constituent elements of the vehicle 2 of the second embodiment are the same as the other constituent elements of the vehicle 1 of the first embodiment.

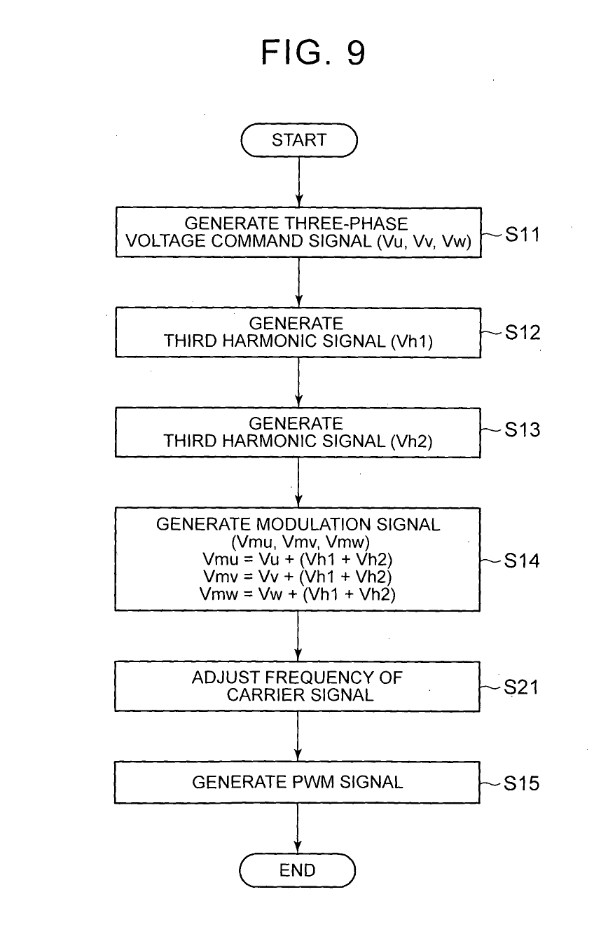

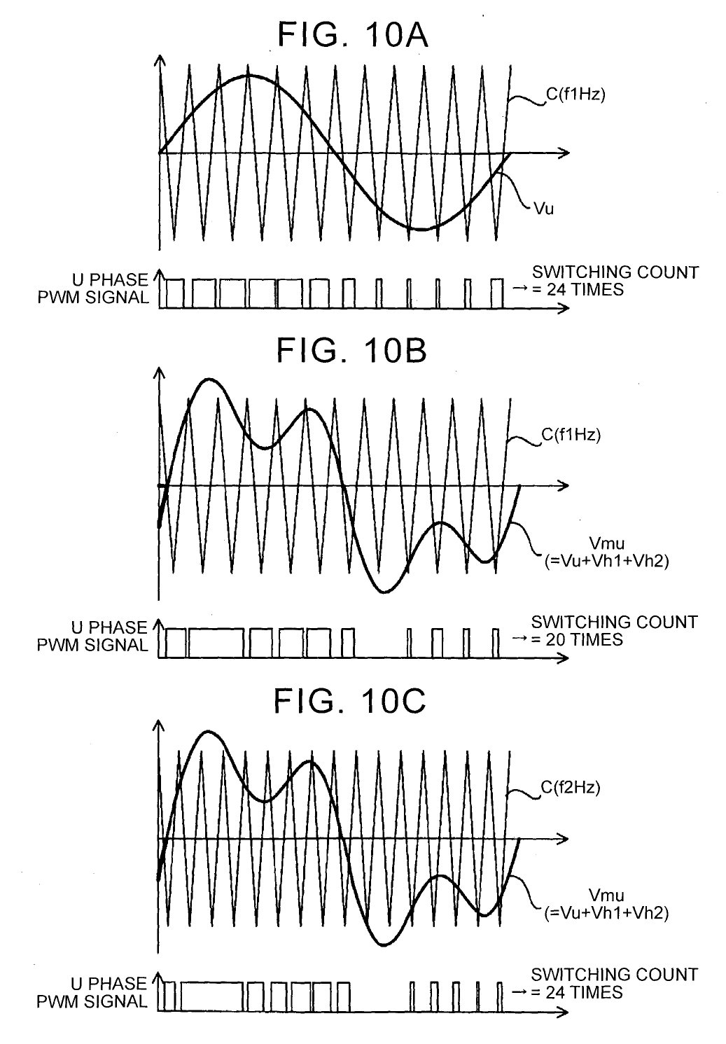

The frequency adjusting unit 258 adjusts a carrier frequency f of the carrier signal C. Note that the adjusting operation of the carrier frequency f that is performed by the frequency adjusting unit 258 will be explained in detail later (with reference to FIGS. 9 and 10A to 10C).

### (2-2) Flow of Inverter Control Operation in Second Embodiment

The flow of the inverter control operation that is performed in the vehicle 2 of the second embodiment (that is, the inverter control operation performed by the ECU 25) is now explained with reference to FIG. 9. FIG. 9 is a flowchart showing the flow of the inverter control operation that is performed in the vehicle 2 of the second embodiment (that is, the inverter control operation performed by the ECU 25).

As shown in FIG. 9, in the second embodiment also, similar to the first embodiment, the operations of step S11 to step S14 are performed. In other words, the three-phase voltage command signal is generated (step S11), the third harmonic signal Vh1 is generated (step S12), the third harmonic signal Vh2 is generated (step S13), and the three-phase modulation signal is generated (step S14).

In the second embodiment, the frequency adjusting unit 258 adjusts the carrier frequency f of the carrier signal C before the PWM converting unit 157 generates the PWM signal (step S21). Subsequently, the PWM converting unit 157 generates the PWM signal using the carrier signal C having the carrier frequency f that was adjusted by the frequency adjusting unit 258 (step S15).

Here, the adjusting operation of the carrier frequency f performed by the frequency adjusting unit 258 is explained with reference to FIGS. 10A to 10C. FIGS. 10A to 10C are graphs showing the magnitude relation of the U phase voltage command signal Vu and the U phase modulation signal Vmu and the carrier signal C, and the U phase PWM signals Gup and Gun that are generated on the basis of the foregoing magnitude relation.

As shown in FIG. 10A, let it be assumed that the U phase PWM signals Gup and Gun are generated on the basis of the magnitude relation of the U phase voltage command signal Vu and the carrier signal C (provided, however, that carrier frequency f=f1). When the p-side switching element Qup and the n-side switching element Qun are driven using the U phase PWM signals Gup and Gun shown in FIG. 10A, the p-side switching element Qup and the n-side switching element Qun respectively perform switching 24 times for each cycle.

Meanwhile, as shown in FIG. 10B, in the second embodiment, similar to the first embodiment, the U phase PWM signals Gup and Gun are generated on the basis of the magnitude relation of the U phase modulation signal Vmu and the carrier signal C (provided, however, that carrier frequency f=f1). When the p-side switching element Qup and the n-side switching element Qun are driven using the U phase PWM signals Gup and Gun shown in FIG. 10B, the p-side switching element Qup and the n-side switching element Qun respectively perform switching 20 times for each cycle. In other words, when the third harmonic signal Vh2 is used, the switching of the p-side switching element Qup and the switching of the n-side switching element Qun will decrease in comparison to the case of not suing the third harmonic signal Vh2. The reason for this is because the absolute value of the signal level of the U phase modulation signal Vmu increases in the amount that the third harmonic signal Vh2 is added to the U phase voltage command signal Vu and, consequently, it becomes easier for the U phase modulation signal Vmu to exceed the apex of the carrier signal C.

Accordingly, if the frequency adjusting unit 258 does not adjust the carrier frequency f, loss in the inverter 13 is reduced in the amount that the switching count is reduced. In other words, when the third harmonic signal Vh2 is added, loss in the inverter 13 is reduced in comparison to the case where the third harmonic signal Vh2 is not added. This kind of effect is realized in the vehicle 1 of the first embodiment that does not include the frequency adjusting unit 258.

Meanwhile, in the second embodiment, the frequency adjusting unit 258 gives preference to increasing the carrier frequency f while maintaining the switching count rather than attempting to reduce the loss in the inverter 13 by reducing the switching count. Specifically, as shown in FIG. 10C, in the second embodiment, the frequency adjusting unit 258 increases the carrier frequency f until the switching count when the third harmonic signal Vh2 is added and the switching count when the third harmonic signal Vh2 is not added coincide. For example, in the example shown in FIG. 10C, the frequency adjusting unit 258 increases the carrier frequency f from f1 to f2 (provided, however, that f2> f1). In the foregoing case, the U phase PWM signals Gup and Gun shown in FIG. 10C are generated. When the p-side switching element Qup and the n-side switching element Qun are driven using the U phase PWM signals Gup and Gun shown in FIG. 10C, the p-side switching element Qup and the n-side switching element Qun respectively perform switching 24 times for each cycle.

As described above, in the second embodiment, when the third harmonic signal Vh2 is added, the switching count of the p-side switching element Qup and the n-side switching element Qun does not increase in comparison to the case where the third harmonic signal Vh2 is not added. Accordingly, in the second embodiment, increase of the carrier frequency f (so-called carrier increase) is realized without inducing the increase of loss in the inverter 13 associated with the increase in the switching count. Consequently, it is possible to realize the effect of not increasing the loss in the inverter 13 by maintaining the switching count, as well as realize the effect of reducing noise in the inverter 13 resulting from the carrier increase.

Note that, in FIGS. 10A to 10C, while the explanation is provided by focusing on the U phase, it goes without saying that the same applies to the V phase and the W phase.

Moreover, the frequency adjusting unit 258 may also increase the carrier frequency f so that the switching count in the case of using the third harmonic signal Vh2 approaches the switching count in the case of not using the third harmonic signal Vh2 (that is, so that the difference between the two will decrease). In other words, the frequency adjusting unit 258 may increase the carrier frequency f while maintaining a state in which the switching count in the case of using the third harmonic signal Vh2 will be smaller than the switching count in the case of not using the third harmonic signal Vh2. In the foregoing case, it is possible to realize the effect of reducing the loss in the inverter 13 by reducing the switching count, as well as realize the effect of reducing noise in the inverter 13 resulting from the carrier increase.

This invention is not limited to the embodiments described above and may be suitably modified to the extent that the modification does not deviate from the gist or concept of the invention that can be understood from the following claims and the overall specification, and a motor controller based on the foregoing modification is also covered by the technical scope of this invention.

What is claimed is:

1. A motor controller for a motor system, including: a DC power supply; a power converter configured to convert DC power supplied from the DC power supply into AC power; a smoothing capacitor electrically connected in parallel with the power converter; and a three-phase AC motor driven with the AC power output from the power converter, the motor controller comprising:
an electronic control unit configured to:
(a) generate a modulation signal by adding a third harmonic signal to a phase voltage command signal that defines an operation of the three-phase AC motor, the third harmonic signal including a first signal component that causes an absolute value of a signal level of the modulation signal to be greater than an absolute value of a signal level of the phase voltage command signal at a timing in which an absolute value of a signal level of a phase current supplied to the three-phase AC motor becomes minimum in each phase of the three-phase AC motor; and
(b) control an operation of the power converter using the modulation signal.

2. The motor controller according to claim 1,
wherein the first signal component includes a signal component in which (i) an absolute value of a signal level becomes greater than zero and (ii) a polarity of the signal level becomes the same as a polarity of the phase voltage command signal of an intended phase at a timing in which the absolute value of the signal level of the phase current of the intended phase becomes minimum.

3. The motor controller according to claim 1,
wherein the first signal component includes a signal component in which (i) an absolute value of a signal level becomes maximum and (ii) a polarity of the signal level becomes the same as a polarity of the phase voltage command signal of an intended phase at a timing in which the absolute value of the signal level of the phase current of the intended phase becomes minimum.

4. The motor controller according to claim 1,
wherein the third harmonic signal includes a second signal component in which an absolute value of a signal level becomes minimum at a timing in which the absolute value of the signal level of the phase voltage command signal becomes minimum.

5. The motor controller according to claim 1, wherein:
the power converter includes a switching element,
the electronic control unit controls the operation of the power converter by controlling the switching element according to a magnitude relation of the modulation signal and a carrier signal of a predetermined frequency, and
the electronic control unit adjusts the frequency of the carrier signal so that a switching count of the switching element controlled on the basis of the modulation signal approaches a switching count of the switching element controlled on the basis of the phase voltage command signal.

6. The motor controller according to claim 5,
wherein the electronic control unit adjusts the frequency of the carrier signal so that the switching count of the switching element controlled on the basis of the modulation signal coincides with the switching count of the switching element controlled on the basis of the phase voltage command signal.

7. The motor controller according to claim 5,
wherein the electronic control unit increases the frequency of the carrier signal.
